(19) United States
(12) Patent Application Publication
(10) Pub. No.: US 2005/0215195 A1
(43) Pub. Date: Sep. 29, 2005

(54) Disposable monikers for wireless privacy and power savings

(76) Inventors: John Light, Beaverton, OR (US); Muralidharan Sundararajan, Portland, OR (US); Trevor A. Pering, Seattle, WA (US); Roy Want, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/808,016

(22) Filed: Mar. 23, 2004

(51) Int. Cl. H04B 7/00

(52) U.S. Cl. 455/41.2; 455/67.11; 455/517

(57) ABSTRACT

A device having a moniker to enhance privacy and power saving is described. According to one embodiment, the moniker is stored within and is associated with a first device. The moniker is provided to a second device, which sends an inquiry message, including the moniker, to the first device. The first device determines whether to respond to the inquiry message based on the moniker.

### TECHNICAL FIELD

Embodiments of the invention relate to the field of wireless communications; and more specifically, the use of a disposable moniker within a wireless network environment.

### BACKGROUND

Discovery of services is an important issue for mobile devices. The common approach, as exemplified by the Bluetooth wireless protocol, is for a mobile device, as a result of explicit action on the part of the user, to Inquire for other Bluetooth devices in its vicinity. The other devices can then respond with a way of contacting them. Then the mobile device can ask each one in turn for a list of services it provides.

The advent of Ubiquitous Computing encourages proactive behavior on the part of the mobile device. That is, it should know of services without explicit action by the user, and it should be able to initiate action on behalf of the user without explicit action. The common approach would require the mobile device to repeatedly and automatically Inquire of services in anticipation of the user's needs. This drains battery power and continually announces the mobile device's presence to the world, violating the user's privacy.

An alternative approach to discovery of services is for devices offering services to announce their presence by Inquiring repeatedly. The mobile device can then choose to answer the Inquiry and ask for a list of services, reducing the number of steps. This still results in the mobile device draining its battery responding to the Inquiries and announcing its presence by doing so.

Thus, a method and system is needed to enhance privacy and power saving of a mobile device.

### BRIEF DESCRIPTION OF THE DRAWINGS

The invention may best be understood by referring to the following description and accompanying drawings that are used to illustrate embodiments of the invention.

FIG. 1 illustrates one embodiment of a mobile device.

FIG. 2 illustrates one embodiment of a network environment suitable for the mobile device.

FIG. 3 illustrates one embodiment of a process flow for using a disposable moniker in a networking environment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

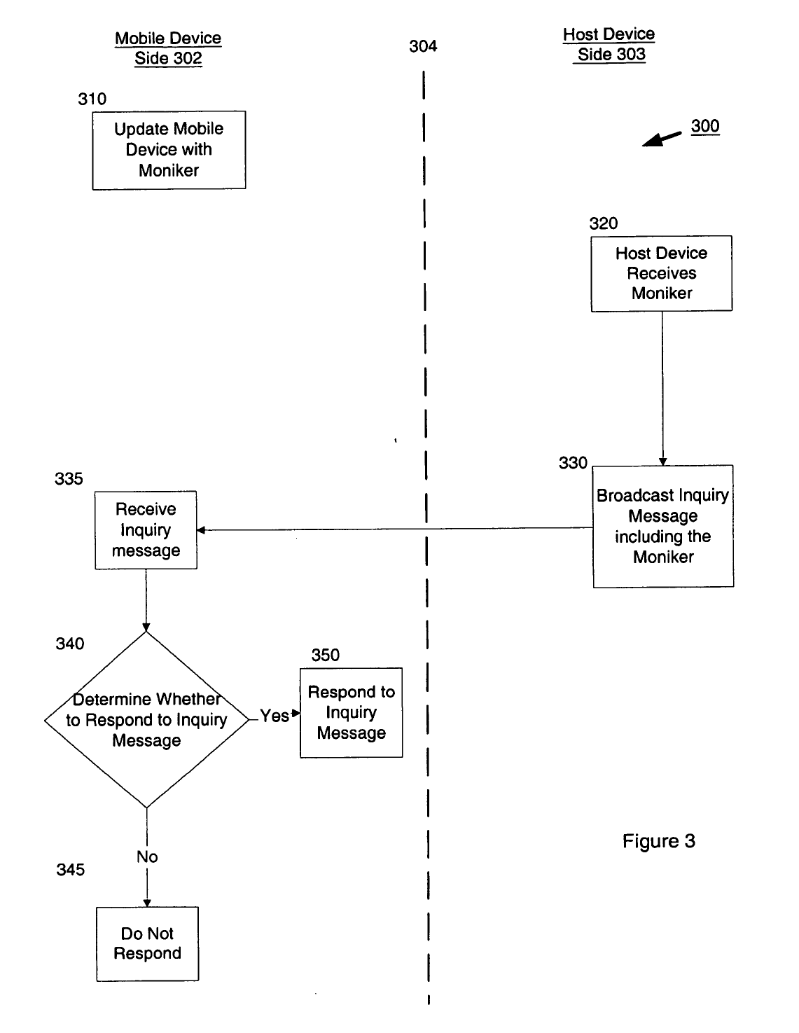

Use of a disposable moniker on a device to enhance privacy and power savings in a wireless environment is described. According to one embodiment of the invention, a mobile device is associated with one or more identifiers (e.g., monikers). When a moniker is presented to a host device, the host device transmits an offer to the mobile device to respond to the host device, which the mobile device may or may not accept, as will be further described below in conjunction with FIG. 3. In this fashion, the mobile device may exist and function effectively in a rich wireless environment while maintaining some privacy.

As will be described, the mobile device is comprised of, but is not limited to, well-known processing, communicating, and storage subsystems, which are combined together to form a compact, low-power mobile device. The mobile device can include, but is not limited to, a file server, a web server, a media server, or any other facilities that a mobile device might have to fundamentally provide data services over a wireless link to another device nearby. The following will describe embodiments of a process where the mobile device may move through multiple environments, where inquiry broadcasts are made, to solicit a type of response. However, the mobile device will only consider responding to inquiry broadcasts that include a moniker that is associated with the mobile device, as will be further described below. The mobile device may include a portable personal computer, a mobile phone, a personal digital assistant (PDA), a personal server, or a wearable system or other mobile devices well known to those of ordinary skill in the art, etc.

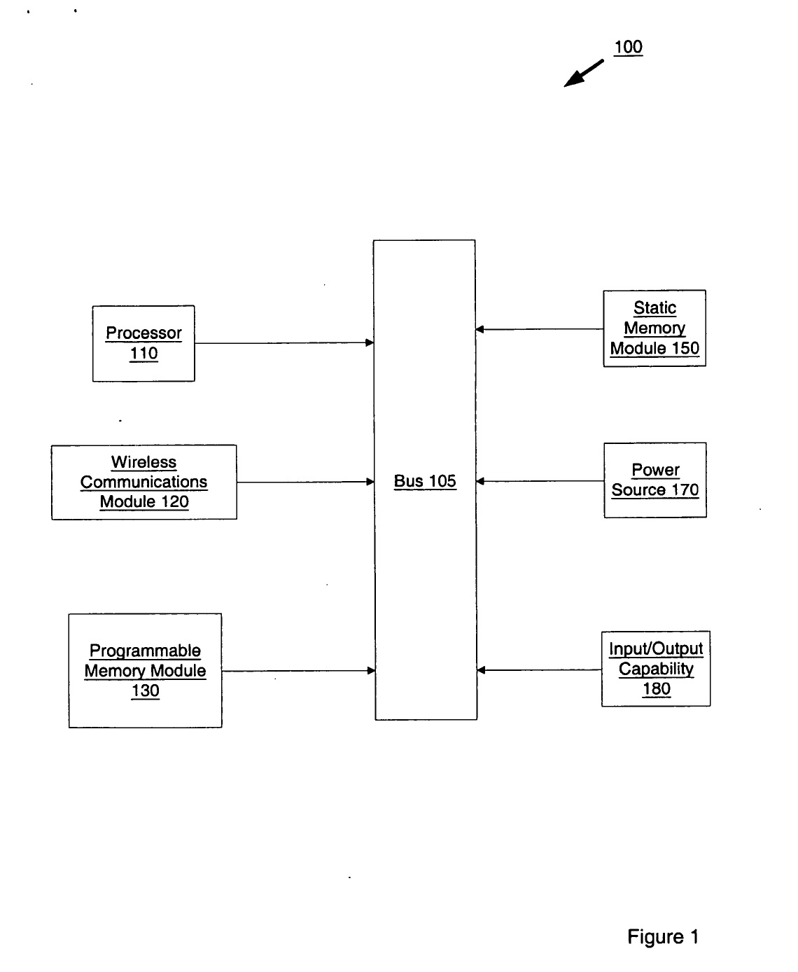

FIG. 1 illustrates one embodiment of a mobile device 100. The mobile device 100 includes, but is not limited to, a processor 110, a wireless communications module 120 (e.g., a Bluetooth Radio by Ericsson Inc of Stockholm Sweden, etc.), a programmable memory module 130 (e.g., Flash memory, etc), a static memory module 150 (e.g., various forms of Random Access Memory (RAM)), a power source 170 (e.g., a 920 mAhr Li-ion power cell), and input/output capabilities 180 (e.g., a keypad, a display screen, a microphone, etc), each connected via a bus 105.

In one embodiment, the wireless communications module 120 provides for device discovery and enables connection to a wide variety of other consumer electronic devices, such as printers, mobile phones, PDAs, user interface/display monitors, audio headsets, etc. For example, the mobile device 100 may have a Bluetooth software stack based on a standard Linux Operating System (OS) release that has been augmented with well-known TCP/IP functionality.

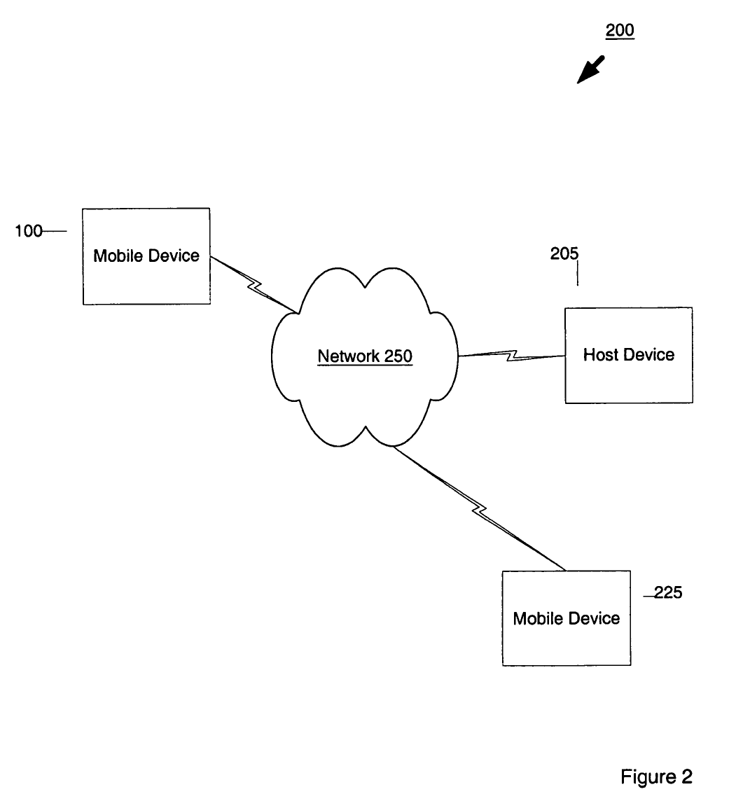

FIG. 2 illustrates one embodiment of a network environment 200 suitable for the mobile device 100. The mobile device 100 is within a communication range of a host device 205 (e.g., a host personal computer, a host mobile device, etc), and a mobile device 225 via a wireless network 250. However, one of ordinary skill in the art will recognize that the mobile device 100 is not necessarily connected to the network 250. The network environment 200 is said to be a dynamic environment network because the mobile devices may dynamically connect to or disconnect from the network 250.

FIG. 3 illustrates one embodiment of a process flow 300 for using a disposable moniker on a mobile device in a networking environment. Line 304 separates the processing of the mobile device side 302 and the host device side 303.

At block 310, the mobile device 100 is updated with one or more monikers. The moniker may be a word, an alphanumeric, a short phrase, a digital image, or digital audio, etc that identifies the mobile device 100. Since one purpose of the moniker is to secure the privacy of the user of the mobile device 100, the moniker should not hint at the identity of the user of the mobile device 100.

At block 320, the host device 205 receives a moniker associated with the mobile device 100. The moniker might be provided to the host device 205 by the user of the mobile device 100 physically inputting (e.g., via a keyboard, a mouse, a pen, a stylus, a microphone, or other well-known input devices) the moniker into the host device 205, the moniker may be hand delivered to a user of the host device 205 to input the moniker, the moniker may be sent via a shared file system or database between the mobile device 100 and the host device 205, or the moniker may be emailed to the host device 205 from a third party device, among other examples.

It is understood that the privacy of the user of the mobile device 100 is not compromised and therefore, is more secure if the mobile device 100 does not directly supply the moniker by making a connection to the host device 205 via the network 250. However, it should be understood that the invention is not limited as such and in alternative embodiments, the mobile device 100 may initiate the direct or indirect communication of the moniker to the host device 205 using various out-of-band communication methods, such as via a cellular communications connect on the mobile device 100.

At block 330, the host device 205 broadcasts an inquiry message including the moniker. For example, the Bluetooth inquiry message may be modified and enhanced to include one or more monikers.

At block 335, the mobile device 100 receives the inquiry message.

At block 340, the mobile device 100 determines whether to respond to the inquiry message received from the host device 205. If the mobile device 100 determines not to respond to the inquiry message, control passes to block 345. If the mobile device 100 determines to respond to the inquiry message, control passes to block 350. The determination of whether to respond may be based on whether the received moniker is associated with the mobile device 100, the mobile device 100 is busy with another connection, the signal strength, or other context of the mobile device 100 or the user of the mobile device 100 upon receiving the inquiry message.

At block 345, the mobile device 100 does not reply to the inquiry message. In this fashion, the privacy of the user of the mobile device 100 is more secure because the mobile device 100 has not formally announced its existence or its identity to the host device 205 and has not consumed the power that a response would have consumed.

At block 350, the mobile device 100 responds to the host device 205. For example, the mobile device 100 may respond with a request for a list of services that the host device 205 is providing, or respond with a list of servers that the mobile device 100 is providing, among other well-known examples.

In this fashion, the mobile device 100 only responds to devices in an environment the user of the mobile device 100 prefers. Furthermore, it should be appreciated that this process provides additional privacy and power saving because the mobile device 100 does not respond to every inquiry message it receives.

It is understood that the user of the mobile device 100 may use the one or more monikers for a short period of time and/or for specific occasions. For example, the moniker may be changed daily, used for work related activities, for personal activities, etc. This change may be made by the user explicitly or by some policy of the mobile device 100 set by the user. As such, the monikers are said to be disposable because they are likely to change for various reasons. Furthermore, the mobile device 100 might respond to more than one moniker. If the user of the mobile device 100 has given different monikers to different people or classes of people, the mobile device 100 could respond to discovery differently depending on context. For example, if the user of the mobile device 100 is late for a meeting, the user might configure the mobile device 100 to temporarily ignore some discovery broadcasts that have a valid moniker while responding briefly to others.

It is also understood that the moniker may represent a group. For example, mobile devices 100 and 225 might both be configured to respond to inquiries that include a specific moniker that represents a group. These group monikers may not necessarily need sanction or administration, other than members of the group sharing them. In this fashion, an inquiry message that includes a group moniker might receive a response from every mobile device (e.g., mobile device 100 and 225) that has listened to and is associated with that group moniker.

It is understood that moniker misuse might occur with the unauthorized use of a moniker by a third-party. For example, a third party may determine a moniker by monitoring broadcast communications that include the moniker. The third party might then transmit a message (e.g., an inquiry message) that includes the misappropriated moniker to gain unauthorized attention from the mobile device associated with the moniker. A user of a mobile device might identify moniker misappropriation and misuse by inspecting a log file for unauthorized use or receiving other indications on the mobile device that unauthorized use has occurred. In addition, moniker misuse can be handled by disposing of the moniker associated with a device on a periodic basis. Also, unlike a wired network, the misuser must be nearby, allowing the user the opportunity to confront the third-party directly. What the moniker protects (an aspect of privacy) provides much less incentive for misuse than, say, an account password. However, in an alternative embodiment, encryption techniques well known in the art may be used to secure the moniker to prevent misuse including, for example, the use of time varying encryption to foil replay attacks outside of the period of the varying time. In yet another embodiment, the moniker may also have a component that includes a time and/or date stamp, so a particular moniker would only be good for a specific amount of time (e.g., a minute or so). In this fashion, the load on the devices might be reduced by automatic processes on each end that would change the time portions.

In addition, one embodiment of the invention may be implemented using a hash of the moniker word, alphanumeric, short phrase, digital image, or digital audio, etc. A hash is a mathematical calculation that summarizes a very large number with a much smaller one. Various methods of calculating a hash are well known to those of ordinary skill in the art. For example, a 32-bit hash of the moniker may be broadcasted instead of the plaintext word, alphanumeric, short phrase, digital image, or digital audio, etc. This greatly reduces the amount of information being broadcast, and it is impractical for a forger to guess the hash value or try all values.

It will be appreciated that more or fewer processes may be incorporated into the method(s) and examples illustrated in FIG. 3 without departing from the scope of the invention and that no particular order is implied by the arrangement of blocks as shown and described herein. It will be further appreciated that the method(s) and examples described in conjunction with FIG. 3 may be embodied in machine-executable instructions (e.g. software). The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-accessible medium having stored thereon instructions that may be used to program a computer (or other electronic devices) to perform the methods. Thus, a machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.). Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

Thus, the use of disposable monikers for wireless privacy and power savings has been described. Although the description describes embodiments of the invention that use the Bluetooth protocol standard, it is understood that the invention is not limited to this embodiment. Rather, in alternative embodiments, other wireless protocols might be used that are well known to those of ordinary skill in the art such as the IEEE 802.15 standards, IEEE 802.11 standards, Zigbee, etc.

While the invention has been described in terms of several embodiments, those skilled in the art will recognize that the invention is not limited to the embodiments described. The methods and apparatus of the invention can be practiced with modification and alteration within the scope of the appended claims. The description is thus to be regarded as illustrative instead of limiting on the invention.

1. A method comprising:
generating a moniker being associated with a first device;
providing the moniker to a second device, the second device including one or more services;
receiving an inquiry message, at the first device, from the second device; and
determining whether the first device should respond to the second device based on the moniker included in the inquiry message.

2. The method of claim 1, wherein the moniker is a word.

3. The method of claim 1, wherein the moniker is a phrase.

4. The method of claim 1, wherein the moniker is alphanumeric.

5. The method of claim 1, wherein the moniker is a digital image.

6. The method of claim 1, wherein the moniker includes digital audio.

7. The method of claim 1, wherein the moniker includes a timestamp.

8. The method of claim 1, wherein the moniker is a hash of at least one of a word, a phrase, an alphanumeric, a digital image, and a digital audio.

9. The method of claim 1, wherein the providing includes manually using an input device at the second device to provide the moniker.

10. The method of claim 1, wherein the providing includes providing the moniker from the first device to the second device using out-of-band communications.

11. A computerized method comprising:
receiving a moniker, the moniker being associated with a mobile device; and
broadcasting an inquiry message, the inquiry message including the moniker.

12. The computerized method of claim 11, wherein receiving the moniker includes receiving the moniker from a local input device.

13. The computerized method of claim 11, wherein the inquiry message is a Bluetooth compatible message enhanced with the moniker.

14. An apparatus comprising:
a communications module to receive an inquiry message, wherein the inquiry message includes a moniker, the communications module to generate a response to the inquiry message upon determining the moniker is associated with the apparatus.

15. The apparatus of claim 14, wherein the determining is based upon a signal strength.

16. The apparatus of claim 14, wherein the determining is based on whether the apparatus is currently connected with a host device.

17. The apparatus of claim 14, wherein the moniker is a word.

18. The apparatus of claim 14, wherein the moniker is a phrase.

19. The apparatus of claim 14, wherein the moniker is an alphanumeric.

20. The apparatus of claim 14, wherein the moniker is a digital image.

21. The apparatus of claim 14, wherein the moniker includes digital audio.

22. The apparatus of claim 14, wherein the moniker includes a timestamp.

23. The apparatus of claim 14, wherein the moniker is a hash of at least one of a word, a phrase, an alphanumeric, a digital image, and a digital audio.

24. An apparatus comprising:
a communications module to send an inquiry message to a mobile device, the inquiry message to include a moniker, the moniker being associated with the mobile device.

25. The apparatus of claim 24, further comprising:
an input device, a user to use the input device to provide the moniker of the mobile device to the apparatus.

26. The apparatus of claim 24, wherein the inquiry message is a Bluetooth compatible message enhanced with the moniker.

27. The apparatus of claim 24, wherein the sending includes sending via wireless communications.

28. A machine-accessible medium that provides instructions that, if executed by a machine, will cause the machine to perform operations comprising:
receiving a moniker, the moniker being associated with a mobile device; and
broadcasting the inquiry message, the inquiry message including the moniker.

29. The machine-accessible medium of claim 28, wherein the receiving the moniker includes receiving the moniker from a local input device.

30. The computerized method of claim 28, wherein the inquiry message is a Bluetooth compatible message enhanced with the moniker.

31. The method of claim 1, further comprising:
storing the moniker within the first device.
